(19) United States
(12) Patent Application Publication
(10) Pub. No.: US 2022/0239514 A1
(43) Pub. Date: Jul. 28, 2022

(54) VIDEO CONFERENCE SYSTEM AND ASSOCIATED COMPUTER PROGRAM PRODUCT

(71) Applicant: alfaview Video Conferencing Systems GmbH & Co. KG, Karlsruhe (DE)

(72) Inventor: Nikolaos Fostiropoulos, Karlsruhe (DE)

(73) Assignee: alfaview Video Conferencing Systems GmbH & Co. KG, Karlsruhe (DE)

(21) Appl. No.: 17/584,494

(22) Filed: Jan. 26, 2022

(30) Foreign Application Priority Data
Jan. 26, 2021 (DE) 102021101645.2

(51) Int. Cl. H04L 12/18; H04L 65/1016; H04L 51/04

(52) U.S. Cl. CPC H04L 12/1822; H04L 51/04; H04L 29/06217; H04L 12/1827

(57) ABSTRACT

A video conference system for bidirectionally transferring video and audio signals between endpoint computers, each having a transmitting device and/or receiving device for audio/video streams, via a computer network. The system has a respective conference client on the relevant endpoint computer; at least one conference server to receive the audio/video streams from the endpoint computers to process and transmit them back; where the conference server makes available for the endpoint computers and/or an associated user at least one virtual room which is accessible to the endpoint computers) and/or an associated user depending on a predefined authorization classification of the endpoint computer and/or of the associated user. Endpoint computers and/or users present in the room are connected to the other endpoint computers and/or users simultaneously present in the room via the conference server. The respective conference client displays the room and enables entry by the endpoint and/or user depending on the authorization classification.

### INCORPORATION BY REFERENCE

The following documents are incorporated herein by reference as if fully set forth: German Patent Application No. 10 2021 101 645.2, filed Jan. 26, 2021.

### TECHNICAL FIELD

The invention relates to a video conference system and to an associated computer program product.

### BACKGROUND

Video conference systems are sufficient known as such. They serve for bidirectionally transferring video and audio signals between a plurality of endpoints or endpoint computers, each having a transmitting device and/or a receiving device for audio streams and/or for video streams, via a computer network, in particular the Internet or a company Intranet. Video conference systems regularly comprise a respective conference client installed and executable on the relevant endpoint computer, and also at least one conference server embodied to receive the audio and/or video streams from the endpoint computers, to process them and to transmit them back or distribute them to the endpoint computers.

Video conferences generally take place in virtual conference rooms that exist only for a limited time. These conference rooms (also referred to hereinafter for short as “rooms”) are usually created only for the purpose of a single meeting by way of corresponding definition on the conference server and are erased again afterward.

Particularly in the context of the current health crisis and the preference for telework owing to this, it has been found that such an organization of video conferences or video conference systems only partly satisfies the requirements in respect of remote cooperation between users. In particular, existing video conference systems often only exhibit little flexibility of use since the definition of conference rooms for meetings is possible for or familiar to few users, which makes it more difficult to implement the cooperation in practice.

### SUMMARY

The invention is based on the object of further developing a video conference system of the type mentioned to the effect of enabling an improved and more flexible cooperation between users who are spatially remote from one another.

Male and female forms of terms such as “participant” or “user” are used with equal validity above and below. The intention is always for both forms to be included—even if not indicated explicitly.

The stated object is achieved according to the invention by a video conference system and/or an associated computer program product having one or more of the features disclosed herein.

On the basis of the present invention the applicant pursues a different approach than that known from conventional video conference systems. In the context of the invention described here, conference rooms are permanently available and can be used repeatedly or again and again. Said rooms thus function as virtual offices which are created not just for the purpose of a single meeting or a single video conference, but rather in order to cooperate permanently with a distributed team. The usability of the video conference system can be greatly extended in this way. Even less experienced users can access the permanently existing rooms in order to cooperate flexibly in groups or subgroups—as would also be possible in a physical building.

A video conference system according to the invention is therefore embodied for bidirectionally transferring video and audio signals between a plurality of endpoint computers, each having a transmitting device and/or a receiving device for audio streams and/or for video streams, via a computer network, in particular the Internet or an Intranet. In general, the endpoint computers each have both a transmitting device and a receiving device for audio streams and for video streams. The video conference system according to the invention comprises a respective conference client installed and executable on the relevant endpoint computer, and also at least one conference server embodied to receive the audio and/or video streams from the endpoint computers, to process them and to transmit them back to the endpoint computers. According to the invention, the conference server is furthermore embodied to make available for the endpoint computers and/or an associated user at least one permanently available virtual room which is accessible to the endpoint computers and/or an associated user depending on a predefined authorization classification (access authorization) of the endpoint computer and/or of the associated user, wherein endpoint computers and/or users present in the room are connected to the other endpoint computers and/or users simultaneously present in the room via the conference server. Furthermore, the respective conference client is embodied to display the at least one room and to enable it to be entered by the endpoint computer and/or user depending on the authorization classification.

The respective endpoint computers are machines (computers) which are operated by an associated user, i.e. a real person. In general, this person, i.e. the user, logs onto the endpoint computer in the video conference system in order to obtain corresponding access to the video conference system. The terms “endpoint computer” and “user” are therefore generally used synonymously hereinafter.

In the context of the present description, the term “permanently” means that a virtual room (conference room) defined on the conference server does not just exist for one-time use, but rather is available a number of times, in particular for an unlimited time, as already indicated further above.

The aforementioned rooms are not physical rooms existing in reality, but rather virtual rooms that exist only on the conference server and enable an exchange of audio/video streams (data streams) originating from different endpoint computers.

In general, the aforementioned users or participants in the video conference system each have a user account, such that they are known to the conference server and are authenticatable by the latter. Moreover, the aforementioned users or participants have an authorization classification (access authorization) stipulating whether a relevant user or participant is or is not permitted to participate in the video conference system and to enter a specific virtual room. Such authorization classifications can be allocated and altered in particular by an administrator of the video conference system.

When it is mentioned in the present case that “endpoint computers and/or users present in a room are connected”, this is taken to mean that said users have logged on with their endpoint computers simultaneously in a (conference) room, such that they each reciprocally receive the audio and/or video streams generated by them.

The room is displayed by the conference client very generally by way of a display or a display device of the relevant endpoint computer. A user can be enabled to enter a room by actuating a button provided for this purpose or by some other operator control process at the conference client.

The endpoint computers are not restricted in terms of technical design; they can be desktop PCs, smartphones, tablet PCs or comparable devices.

A first development of the video conference system according to the invention provides that within a customer account a plurality of rooms are definable and preferably arrangeable in a multidimensional room structure. In this way, within each customer account within the video conference system rooms can be arranged individually in a multidimensional structure in order for example to represent an organization structure or a building structure (existing in reality).

Here and hereinafter, the term “customer” denotes a (superordinate) user of the video conference system, i.e. e.g. an authority, an educational institution or a company, which user subsequently enables (subordinate) users or participants (i.e. generally persons existing in reality, e.g. employees or students) to use the video conference system by setting up user accounts corresponding to the users (see above). A customer has a corresponding customer account.

Another development of the video conference system according to the invention provides that parts of the room structure are visible or hidden to a given user depending on the authorization classification thereof. That is to say that only parts of the structure are visible or hidden to users depending on authorization. In this regard, for example, the personnel administration of a company can occupy a room that is accessible to all users, while the rooms for management allow access only for certain users.

The design of the room structure within a customer account can be manifested differently depending on requirements. A small company requires only a few rooms, under certain circumstances, and these rooms can simply be listed linearly one below another. A university, by contrast, can create a highly ramified structure in order to represent e.g. faculties or central institutions. Accordingly, yet another development of the video conference system according to the invention provides that a design of the room structure is different depending on the type of customer or customer account, in particular listed linearly one below another or as a ramified structure.

Advantageously, a distinction is drawn between departments and rooms, where departments should be regarded as structural elements which can in turn contain further departments and rooms. A corresponding development of the video conference system according to the invention provides that departments are also defined or definable besides rooms, which departments represent structural elements which can in turn contain further departments and/or rooms.

In order to facilitate operation of the video conference system according to the invention for the user, a corresponding development of said video conference system can provide in particular that rooms and/or departments are creatable via a web-based administration interface and are arrangeable in an arbitrary structure preferably by drag & drop.

As part of yet another development of the video conference system according to the invention, it can also be provided that rooms and/or departments are collectively or individually configurable in order to allocate an access authorization and an authorization classification in each case to users or groups of users. In this way, the usability of the video conference system according to the invention can be embodied in an individualized manner. By way of example, all users can obtain access to all rooms of a specific department; alternatively, which user has access and which does not can be controlled separately for each room (of a department).

In order to obtain a comprehensive overview of the work possibilities within the video conference system according to the invention, logged-on users, within the conference client, preferably see a graphical representation of the room structure. In this case, departments and their subordinate structure can be “collapsed” or masked out for the sake of better overview in the display. A corresponding development of the video conference system according to the invention therefore provides that the conference client is embodied to display a (graphical) representation of the room structure to users logged onto the conference server. Advantageously, in the context of a corresponding development of the video conference system according to the invention, it can also be provided that departments and optionally their subordinate room structure(s) are able to be inserted and masked out in the representation by means of the conference client. The representation of the video conference system becomes simpler as a result and affords a better overview for the user.

Rooms can be selected and entered by the user by means of an “enter” button or by some other selection process. The users can thus move intuitively in the room structure, provided that the respective access authorization has been granted. A corresponding development of the video conference system according to the invention therefore provides that rooms are enterable by means of an assigned operator button of the conference client provided that a relevant user has the respective authorization classification for access. If no authorization classification for entering a room is present, the button can be masked out or inactivated.

When a room is entered, preferably the audio and video streams of all users staying therein are combined together, such that all relevant users can hear and see one another. When the room is left the audio and video streams are correspondingly separated again (by the conference server). For this purpose, a video conference system according to the invention can be embodied to combine together the audio and video streams of all relevant users when the users enter a room, and to separate said streams again when the users leave the room, in particular also progressively for individual users. This means that further users can enter a room even at a later time so as then to be correspondingly connected to all the users already present. Conversely, any user can leave the room again at any time (earlier), whereupon said user's audio and video streams are separated from the audio and video streams of the other users remaining in the room.

Advantageously, in the context of yet another development of the video conference system according to the invention, it is provided that a duration of stay in a room is temporally unlimited, wherein leaving a room is preferably able to be effected by closing the conference client or by entering a different room.

As part of a particularly advantageous development of the video conference system according to the invention, it is provided that a user (preferably using only one user account) stays in a plurality of rooms simultaneously. It is thereby possible to ensure that a plurality of groups of persons simultaneously see the audio and video streams of said user. By way of example, in this way a professor can stay both in a virtual lecture room 1 and in a virtual lecture room 2 in order to thereby reach a larger number of students.

It has been found to be particularly advantageous if each room consists, in principle, of the main room and an arbitrary number of further rooms, so-called group rooms. Group rooms can be used for further structuring or else to carry out ad hoc, i.e. spontaneously, meetings in changing compositions, without leaving the actual room in the process. A corresponding development of the video conference system according to the invention thus provides that each room comprises a main room and an arbitrary number of group rooms, which group rooms are preferably usable for further structuring and/or for carrying out ad hoc conferences in changing compositions, without leaving the superordinate room in the process.

Within the conference client, the current room or the main room with its subgroups (group rooms) is advantageously represented clearly in a list, wherein those users who are currently staying in the respective room (main room or group room) are additionally represented as well in order in particular to enable a user to select a room in a targeted manner, in order to meet certain users there. For this purpose, another development of the video conference system according to the invention can provide that the conference client is embodied to represent a current room or the main room with the associated group rooms in a list, preferably in each case together with the operator button mentioned further above, wherein extremely preferably those users and/or a number of those users who are currently staying in a specific main room or group room are additionally representable.

Communication within the room structure constitutes a particularly important aspect of video conference systems. In order to ensure communication across room boundaries, too, in the context of the present invention, text messages can be sent in the context of one advantageous development, which text messages are distributed as necessary to the entire room structure or the users staying therein. However, it is also possible to define only parts of the room structure as recipient of such a text message, or else to address only a room, a subroom or an individual user. In the context of a corresponding development of the invention, the proposed video conference system therefore additionally also has a text message function for generating text messages, which text messages are distributable to the entire room structure and the users staying therein, wherein preferably also only parts of the room structure, at least one room, at least one group room and/or at least one individual user is/are definable as recipient of such a text message. To that end, it can furthermore be provided that e.g. a context menu is able to be used to select the recipient to which the text message is intended to be transmitted (e.g. to a specific person, a room or subroom (main room or group room), a department or a company).

In accordance with a second aspect of the present invention, the object defined further above is also achieved by means of a computer program product having program information stored or storable on a physical data carrier, upon the execution of which program information on a computer system having a number of endpoints connected or connectable via communication channels and each having a transmitting device and/or a receiving device for audio streams and/or for video streams, a video conference system according to the invention for bidirectionally transferring video and audio signals is embodied or embodiable, as described in detail above. This also applies to the developments of the video conference system according to the invention that have been described in detail.

### BRIEF DESCRIPTION OF THE DRAWINGS

Further properties and advantages of the invention will become apparent from the following description of exemplary embodiments with reference to the drawing.

FIG. 1A schematically shows an embodiment of the video conference system;

FIG. 1B schematically shows a possible use of the video conference system in accordance with FIG. 1A;

FIG. 2 schematically shows a possible representation of the room structure;

FIG. 3 schematically shows an alternative representation of the room structure;

FIG. 4 shows another representation of the room structure together with associated buttons;

FIG. 5 shows an alternative representation of the room structure in relation to FIG. 4; and

FIG. 6 shows yet another representation of the room structure with group rooms and a display of the users staying there.

### DETAILED DESCRIPTION

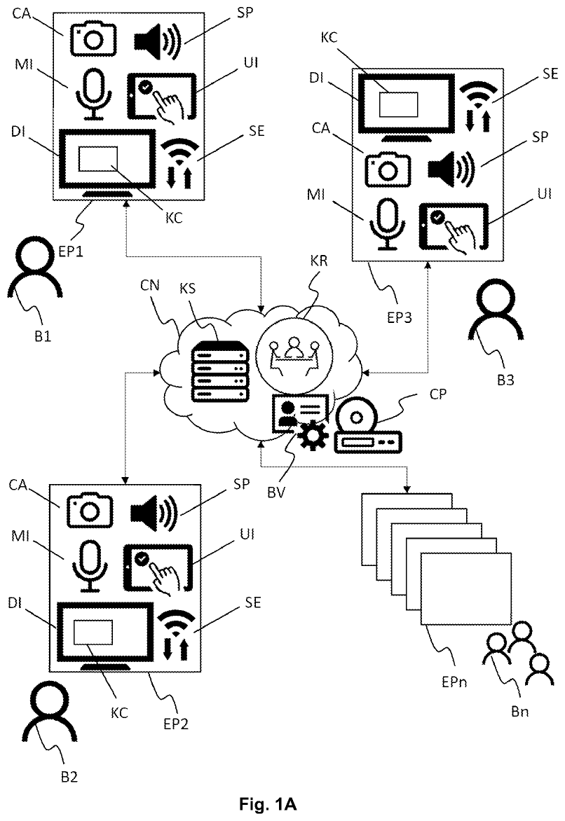

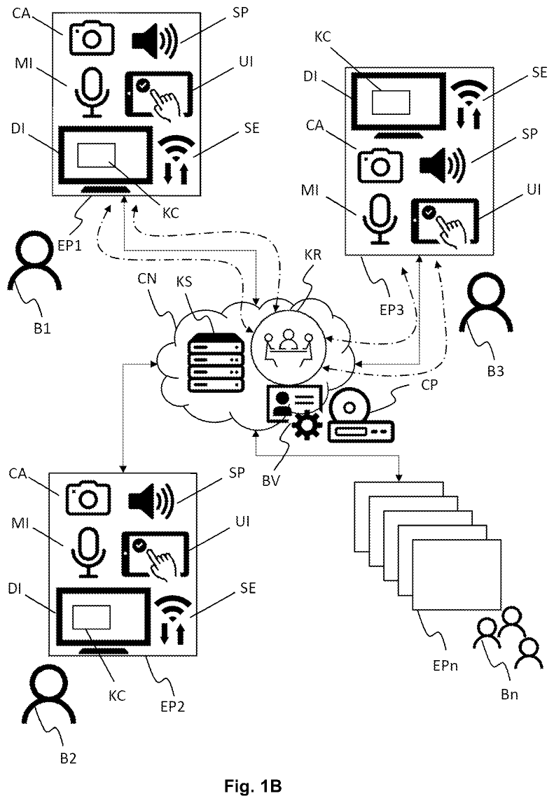

FIG. 1A shows a video conference system according to the invention with a series of participants arranged at different endpoints of the video conference system. In principle, all the endpoints of the video conference system can be embodied or equipped in a technically equivalent manner; this is correspondingly illustrated in the figures—however, the shown technical equipment of the individual endpoints or of the endpoint computers present there is not restricted to the technical equipment shown by way of example. In particular, different endpoint computers (PCs, tablets, smartphones, . . . ) can also be used at the endpoints, provided that they satisfy certain minimum requirements.

The technical embodiment of the individual endpoints (or endpoint computers) of the video conference system has also already been presented further above in the general part of the description. The terms “endpoints” and “endpoint computers” are used synonymously below.

In accordance with FIG. 1A, the video conference system firstly comprises a first endpoint EP1, which—without any restriction—can be assigned to an instructor, a presenter or generally a (VIP) user. Correspondingly, a second endpoint EP2 is assigned to a second user B2 and a third endpoint EP3 is assigned to a third user B3. Further endpoints EPn can exist, to each of which in turn a user Bn can correspondingly be assigned. In principle, the number of endpoints of the video conference system is unlimited within the scope of the technical possibilities.

The aforementioned endpoints EP1-EPn are connected to one another via a computer network CN. The computer network CN is preferably the worldwide Internet or a company Intranet. In principle, however, the invention is not restricted to a specific type of computer network CN.

The communication of the endpoints EP1-EPn in the computer network CN is effected according to a conference server KS equipped accordingly in terms of hardware and software technology. In particular, the conference server KS can have a so-called multipoint control unit, MCU for short, this involving a central star distributor for video conferences. An MCU can be realized as hardware or software and is known as such to a person skilled in the art. By way of an MCU, the data streams from a plurality of conference participants (users) are received, processed depending on the configuration of the MCU and transmitted back to the participants.

The conference server KS or the video conference system overall has a user administration BV (set up in terms of software technology) for managing user accounts of the individual users, which in particular also register the access authorizations of the individual users to the video conference system overall or the room structure discussed further above. The users log onto the conference server KS in their respective user account and then have predefined rights concerning the use of the video conference system. This will be discussed in even greater detail further below.

Furthermore, at least one permanently set up virtual conference room KR is defined on the conference server KS and can be accessed by the users—given corresponding access authorization—at any time in order to meet further users of the video conference system. In general, a plurality of such permanently set up virtual conference rooms KR are defined on the conference server KS, which will likewise be discussed in even greater detail below.

The individual endpoints EP1-EPn are able to exchange data streams via the computer network CN, in the context of the present invention preferably audio streams (sound) and video streams (image). In order to be able to generate such data streams, all the endpoints (EP1-EPn) have a camera CA and a microphone MI. Furthermore, all the endpoints EP1-EPn have transmitting and receiving devices for the aforementioned data streams, this being symbolized by reference signs SE in FIG. 1a. These devices can, but need not, be embodied in wireless fashion. In accordance with the embodiment in FIG. 1a, all the endpoints additionally have suitable output/reproduction devices for received data streams, illustrated here in the form of a display DI for received video streams and a loudspeaker SP for received audio streams. Furthermore, the endpoints EP1-EPn each have a user interface UI, which can be embodied as a graphical user interface (GUI), as is symbolized in particular in FIG. 1a. The user interface UI can be part of the display DI, or this can involve some other input possibility, such as a keyboard, a mouse or the like. In the present case, a conference client, i.e. corresponding client software for participation in the video conference system, is embodied on each endpoint computer. This is symbolized in each case by a rectangle KC on the display DI in FIG. 1A.

Reference sign CP designates a data carrier and a corresponding reader, this being intended to illustrate that corresponding program instructions (program code) required for setting up the video conference system and its components or for carrying out a method according to the invention with the aid of the video conference system shown can be stored or storable on a corresponding data carrier in order to equip (set up) the video conference system including the clients (endpoint computers) accordingly. However, it is not necessary in principle for the aforementioned program instructions to be present on a physical data carrier; alternatively or additionally, a download in appropriately immaterial form, e.g. from the Internet, is conceivable as well.

It has already been indicated that user B1 can be an instructor or a presenter. In the context of a preferred application of the video conference system, the user B2 is a “normal” participant, for example a trainee who would like to follow a presentation given by the presenter B1. User B3 is an arbitrary further listener in this case. However, the aforementioned distribution of roles is of no further significance in the context of the present invention.

The further users or participants Bn can be in particular further “normal” participants corresponding to participant B2 or further presenters corresponding to participant B1. Here, too, there is no restriction of the present invention.

FIG. 1B shows how the video conference system in accordance with FIG. 1A can advantageously be used. This results in a particular method for transferring information, here in particular the audio and video streams mentioned, by means of streaming technology via communication channels, which communication channels are formed between the illustrated endpoints EP1 to EP3.

In accordance with the illustration in FIG. 1B, the user B1 and the user B3 have dialed into the permanently provided conference room KR. They can now mutually hear and see one another because their audio and video streams are correspondingly linked, as symbolized by the dash-dotted arrows in FIG. 1B. This is done accordingly as stipulated by the conference server KS. In accordance with FIG. 1B, the user B2 is not yet participating in the meeting at the present time, but could also himself/herself dial into the conference room KR even at a later time in order to participate in the meeting with the users B1 and B3. The same applies—assuming corresponding access authorizations—to the further users Bn as well.

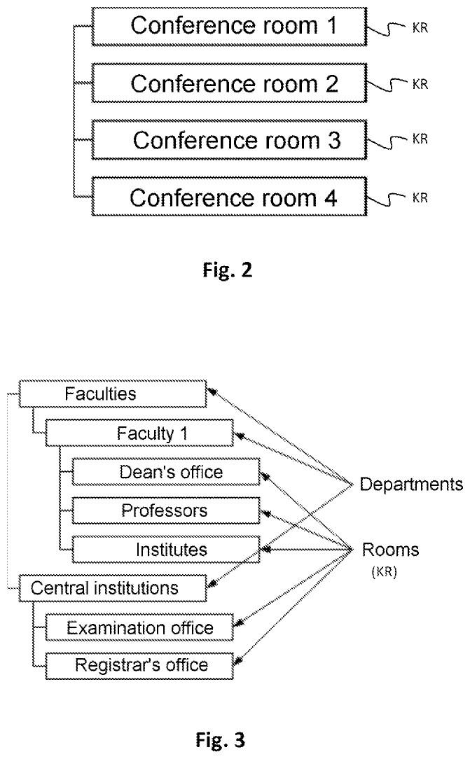

The invention—as has already been mentioned—is in no way restricted to only a single conference room KR being permanently defined on the conference server KS. Depending on a customer's requirements, the design of the room structure within an associated customer account, i.e. a possibility for use of the video conference system by the relevant customer (a company, an organization, a group of private persons, . . . ), can be manifested differently. A small company requires only a few rooms, under certain circumstances, and these rooms can be listed linearly one below another, in particular. This is illustrated schematically in FIG. 2. FIG. 2 shows a room structure comprising just four rooms, designated respectively as “conference room #”. A university as an example of a larger organization, by contrast, can create a highly ramified (room) structure on the conference server KS in order to represent e.g. faculties or central institutions. This is illustrated by way of example in FIG. 3.

The (room) structure in accordance with FIG. 3 comprises a series of so-called departments, here the aforementioned faculties or central institutions, and also a number of rooms corresponding to the conference room KR in FIGS. 1A, 1B, which are structurally subordinate to the departments and serve in turn as permanently set up conference rooms.

In this case, a distinction should be drawn between departments and rooms from a functional standpoint, since departments should be regarded as pure order-imparting structural elements which can in turn contain further departments and rooms (the actual conference rooms).

Advantageously, both departments and rooms can be created in a simple manner by way of a web-based administration interface and be arranged in an arbitrary structure by drag & drop, for example, this not being illustrated any further in the drawings. However, the invention is in no way restricted in this regard and also encompasses other possibilities for creating the structures shown. In this case, departments and rooms can be configured collectively, i.e. jointly, or in each case individually in order to allocate to users or groups of users corresponding access authorizations or authorization levels, which are then correspondingly stored in the user administration BV on the conference server KS (cf. FIGS. 1A and 1B).

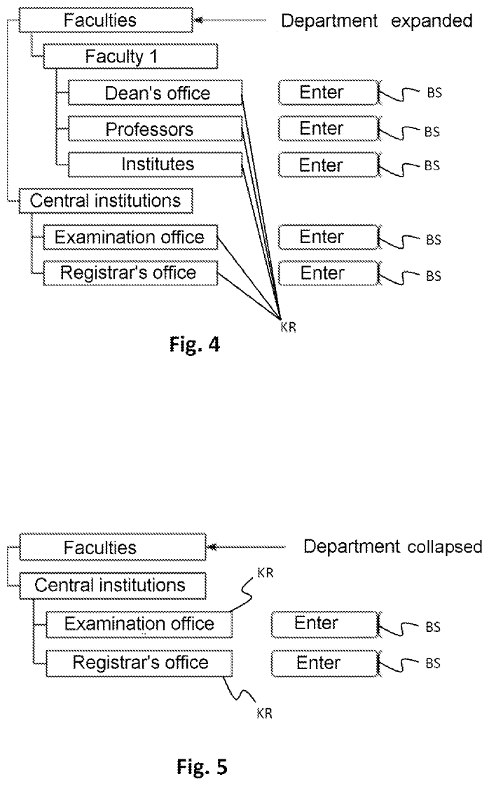

FIGS. 4 and 5, in particular, show exemplary representations of the room structure such as are seen by users logged onto the conference server KS when the representation of the room structure is displayed to said users within the client software (conference client KC, cf. FIGS. 1A and 1B). Departments and their respectively subordinate structure can be “expanded” or “collapsed” for the sake of better overview, e.g. by clicking. In FIG. 4, for example, the department “faculties” is represented in expanded form (as indicated), such that it is possible to discern the further department arranged underneath “faculty 1” with the associated rooms “dean's office”, “professors” and “institutes”, which respectively correspond to the conference room KR in FIGS. 1A, 1B. The same applies to the department “central institutions” with the rooms “examination office” and “registrar's office”. The aforementioned rooms can be entered by means of the respectively assigned “enter” button BS if a corresponding selection is made by the user. The users can thus move intuitively in the room structure, provided that the respective access authorization has been granted.

When a room is entered, audio and video streams of all users staying therein are combined with one another, such that everyone can hear and see one another. This has already been pointed out many times. When a room is left, said audio and video streams are correspondingly separated again. The duration of stay in a room is temporally unlimited. The room can be left either by closing the application (the conference client) or by entering a different room.

In accordance with FIG. 5, by way of example the department “faculties” has been collapsed, such that it is no longer explicitly represented for the user, in order to increase the clarity of the representation. It can be provided that the user can expand the relevant department again by selecting the relevant display region, for example by clicking using a mouse.

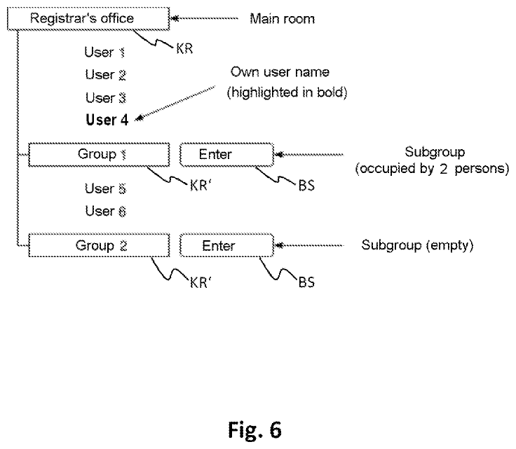

It has already been pointed out that groups can advantageous be defined within a room in order to further improve the useability of the video conference system. In the case of corresponding embodiment, each room consists of a main room KR and an arbitrary number of so-called group rooms KR′, as is illustrated by way of example in FIG. 6. Group rooms KR′ can be used for further structuring or else to carry out ad hoc meetings in changing compositions, without leaving the actual room (the main room KR).

Within the client software (conference client KC, cf. FIGS. 1A and 1B), the current room or the main room KR with its subgroups (group rooms) is preferably represented clearly in a list, wherein the users who are currently staying in a relevant room (main room KR or group room KR′) are additionally represented.

As shown in FIG. 6, “registrar's office” represents a main room KR, in which the users 1 to 4 are staying at the present time. In this case, in accordance with the representation in FIG. 6, the (own) user name of the user under consideration, here user 4, is highlighted (in bold). The aforementioned main room KR has two group rooms KR′ (“group 1” and “group 2”), with users (user 5 and user 6) staying only in the first-mentioned group room KR′. The other subgroup (group room KR′) is empty. Once again “enter” buttons BS are found alongside the group rooms KR′, said buttons being used to reach the respective group room KR in order to participate in a video conference there.

Main room and group rooms correspond functionally to the conference room KR in FIGS. 1A, 1B. Upon the main room or group rooms being entered, audio and video streams of all users staying therein are combined with one another, such that everyone can hear and see one another. When the respective room is left, these audio and video streams are correspondingly separated again, as already described a number of times.

1. A video conference system configured for bidirectionally transferring video and audio signals between a plurality of endpoint computers (EP1-EP3, EPn), each having at least one of a transmitting device or a receiving device (SE) for at least one of audio streams or video streams, via a computer network (CN), the system comprising:
a respective conference client (KC) installed and executable on a relevant one of the endpoint computers (EP1-EP3);
at least one conference server (KS) configured to receive the at least one of the audio or video streams from the endpoint computers (EP1-EP3, EPn), to process them and to transmit them back to the endpoint computers (EP1-EP3, EPn);
the conference server (KS) is further configured to make available for at least one of the endpoint computers (EP1-EP3, EPn) or an associated user (B1-Bn) at least one permanently available virtual room (KR) which is accessible to the at least one of the endpoint computers (EP1-EP3, EPn) or the associated user (B1-Bn) depending on a predefined authorization classification of the at least one of the endpoint computer (EP1-EP3, EPn) or the associated user (B1-Bn), wherein the at least one of the endpoint computers (EP1, EP3) or the associated users (B1, B3) present in the room (KR) are connected to the other ones of the at least one of the endpoint computers (EP1, EP3) or the associated users (B1, B3) simultaneously present in the room (KR) via the conference server (KS); and
the respective conference client (KC) is configured to display the at least one room (KR) and to enable the at least one room to be entered by the at least one of the endpoint computer (EP1-EP3, EPn) or associated user (B1-Bn) depending on the authorization classification.

2. The video conference system as claimed in claim 1, wherein within a customer account a plurality of rooms (KR) are definable in a multidimensional room structure.

3. The video conference system as claimed in claim 2, wherein parts of the room structure are visible or hidden to a given user (B1-Bn) depending on the authorization classification thereof.

4. The video conference system as claimed in claim 2, wherein a configuration of the room structure is different depending on a type of the customer account.

5. The video conference system as claimed in claim 1, wherein departments are defined or definable in addition to the rooms (KR), said departments represent structural elements which can in turn contain at least one of further departments or rooms (KR).

6. The video conference system as claimed in 5, wherein at least one of the rooms (KR) or the departments are creatable via a web-based administration interface and are arrangeable in an arbitrary structure.

7. The video conference system as claimed in claim 6, wherein at least one of the rooms of the departments are collectively or individually configurable in order to allocate an access authorization and an authorization classification in each case to the users (B1-Bn) or groups of the users (B1-Bn).

8. The video conference system as claimed in claim 2, wherein the conference client (KC) is configured to display a representation of the room structure to users (B1-Bn) logged onto the conference server (KS).

9. The video conference system as claimed in claim 5, wherein at least one of the departments or a subordinate room structure of the departments are able to be masked out in a representation by the conference client (KC).

10. The video conference system as claimed in claim 1, wherein the rooms (KR) are enterable by an assigned operator button (BS) of the conference client (KC) provided that a relevant one of the users (B1-Bn) has the respective authorization classification for access.

11. The video conference system as claimed in claim 1, where in the system is configured to combine together the audio and video streams of all relevant ones of the users (B1, B3) when the users (B1, B3) enter one of the rooms (KR), and to separate said streams again when the users (B1, B3) leave the room (KR).

12. The video conference system as claimed in claim 1, wherein a duration of stay in one of the rooms (KR) is temporally unlimited, wherein leaving said room (KR) is effected by closing the conference client (KC) or by entering a different one of the rooms (KR).

13. The video conference system as claimed in claim 1, wherein the system is configured to the effect that one of the users (B1-B3, Bn) can stay in a plurality of rooms (KR) simultaneously.

14. The video conference system as claimed in claim 1, wherein at least one of the rooms comprises a main room (KR) and an arbitrary number of group rooms (KR), said group rooms (KR′) being usable for further structuring and/or for carrying out ad hoc conferences in changing compositions, without leaving the main room (KR) in the process.

15. The video conference system as claimed in claim 14, wherein the conference client is embodied to represent a current one of the rooms or the main room (KR with the group rooms (KR′) in a list, and at least one of the users (B1-Bn) or a number of the users (B1-Bn) who are currently staying in the current one of the rooms or the main room (KR) or the group room (KR′) are additionally representable.

16. The video conference system as claimed in claim 2, further comprising an additional text message function for generating text messages, said text messages are distributable to an entirety of the room structure and the users staying therein, or to only parts of the room structure, at least one room (KR), at least one group room (KR′) or at least one individual one of the users (B1-Bn).

17. A computer program product (CP) comprising program information stored or storable on a physical data carrier, upon execution of which program information on a computer system having a number of endpoints (EP1-EP3, EPn) connected or connectable via communication channels and each having at least one of transmitting device (SE) or a receiving device (SE) for at least one of audio streams or for video streams, forms the video conference system for bidirectionally transferring video and audio signals as claimed in claim 1.
